(19) United States
(12) Patent Application Publication
(10) Pub. No.: US 2025/0383479 A1
(43) Pub. Date: Dec. 18, 2025

(54) OPTICAL DEVICE AND METHOD OF FABRICATING THE SAME

(71) Applicant: WUHAN XINXIN SEMICONDUCTOR MANUFACTURING CO., LTD., Wuhan (CN)

(72) Inventors: Cong WU, Wuhan (CN); Deyuan LI, Wuhan (CN); Liliang GU, Wuhan (CN); Yan XIE, Wuhan (CN); Danqing WEI, Wuhan (CN)

(21) Appl. No.: 19/174,138

(22) Filed: Apr. 9, 2025

(30) Foreign Application Priority Data
Jun. 13, 2024 (CN) 202410764820.1

(51) Int. Cl. G02B 3/00

(52) U.S. Cl. CPC G02B 3/0025

(57) ABSTRACT

The present invention provides an optical device and a method of fabricating the same. A first dielectric layer is formed on a substrate structure and then patterned and partially removed, forming openings therein, which define at least one first dielectric sub-layer in the first dielectric layer. The first dielectric sub-layer is rounded into a microlens. In this way, the microlens can be fabricated in a chip fabrication plant, without needing to deliver an associated chip to a dedicated microlens fabrication plant, thereby improving production efficiency and shortening the manufacturing cycle. The microlens can be fabricated in the optical device using a semiconductor process and thus exhibits increased density and uniformity, resulting in higher optical efficiency.

### CROSS-REFERENCE TO RELATED APPLICATION

This application claims the priority of Chinese patent application number 202410764820.1, filed on Jun. 13, 2024 and entitled “OPTICAL DEVICE AND METHOD OF FABRICATING THE SAME”, the entire contents of which are incorporated herein by reference.

### TECHNICAL FIELD

The present invention relates to the field of semiconductor technology, and in particular to an optical device and a method of fabricating the same.

### BACKGROUND

Nowadays, the manufacturing of optical devices (CIS's, SPADs, etc.) typically starts with the fabrication of associated chips in a chip fabrication plant, which are then delivered to a microlens fabrication plant for the fabrication of microlenses thereon. As transportation and other handling take time, the manufacturing cycle of the optical devices is long. In addition, microlenses made with conventional processes are hardly suitable for use in high-performance equipment due to poor density and uniformity and low optical efficiency.

### SUMMARY

It is an object of the present invention to provide an optical device and a method of fabricating the same, which overcome at least one of the above-described problems with conventional optical devices, namely, a long manufacturing cycle and/or poor density and uniformity and low optical efficiency of microlenses therein.

To this end, the present invention provides a method of fabricating an optical device, including:
providing a substrate structure;
forming a first dielectric layer on the substrate structure; and
patterning and thereby partially removing the first dielectric layer to form openings therein, which define at least one first dielectric sub-layer in the first dielectric layer, and rounding the first dielectric sub-layer into a microlens.

Optionally, in the method, rounding the first dielectric sub-layer may include:
forming a patterned mask layer on the first dielectric sub-layer and etching portions of the first dielectric sub-layer connecting a surface and side surfaces thereof, with the patterned mask layer serving as a mask, thereby forming curved surfaces.

Optionally, in the method, edge surface portions of the first dielectric sub-layer may be exposed from the patterned mask layer, wherein etching the portions of the first dielectric sub-layer connecting the surface and the side surfaces thereof includes:
etching the edge surface portions of the first dielectric sub-layer.

Optionally, in the method, forming the patterned mask layer may include: forming a first mask layer on the first dielectric layer;
patterning the first mask layer into a first basic-pattern mask layer and, with the first basic-pattern mask layer serving as a mask, etching and thinning the first dielectric layer to form the openings; and
partially removing the first basic-pattern mask layer with its width narrowed to form the patterned mask layer.

Optionally, in the method, rounding the first dielectric sub-layer after its portions connecting the surface and the side surfaces thereof are etched may further include:
repeating, once or multiple times, a process consisting of: partially removing the patterned mask layer with its width narrowed to expose edge surface portions of the first dielectric sub-layer; and with a patterned mask layer resulting from the partial removal serving as a mask, etching the exposed edge surface portions of the first dielectric sub-layer.

Optionally, in the method, the patterned mask layer may cover edge surface portions of the first dielectric sub-layer, wherein etching the portions of the first dielectric sub-layer connecting the surface and the side surfaces thereof includes:
etching the first dielectric sub-layer at an etch selectivity ratio less than X:1 of the first dielectric sub-layer to edge portions of the patterned mask layer and at an etch selectivity ratio greater than X:1 of the first dielectric sub-layer to a central portion of the patterned mask layer.

Optionally, in the method, forming the patterned mask layer may include:
successively forming a second dielectric layer and a second mask layer above the first dielectric layer; and
patterning the second mask layer into a second basic-pattern mask layer, etching the second dielectric layer to form the patterned mask layer, with the second basic-pattern mask layer serving as a mask, and thinning the first dielectric layer to form the opening.

Optionally, in the method, rounding the first dielectric sub-layer may include:
forming a third dielectric layer, which covers at least side surfaces of the first dielectric sub-layer, thereby forming curved surfaces connecting a surface of the first dielectric sub-layer to the side surfaces thereof.

Optionally, in the method, the first dielectric sub-layer may include at least two sub-sub-layers having cross-sectional widths measured parallel to a surface of the substrate structure, which progressively increase from the side away from the substrate structure to the side proximal to the substrate structure,
wherein the third dielectric layer covers side surfaces of each sub-sub-layer.

Optionally, in the method, the openings may further define a second dielectric sub-layer in the first dielectric layer below the first dielectric sub-layer.

Optionally, in the method, at the same time as the first dielectric sub-layer is rounded, the second dielectric sub-layer may be patterned and/or rounded.

The present invention also provides an optical device including a substrate structure and a microlens on the substrate structure, wherein the microlens is formed by patterning and rounding a first dielectric layer on the substrate structure.

Optionally, in the optical device, the microlens may be made of silicon oxide.

Optionally, in the optical device, the microlens may be obtained according to the method as defined above.

In the optical device and method of the present invention, the first dielectric layer is formed on the substrate structure and then patterned and partially removed, forming openings therein, which define at least one first dielectric sub-layer in the first dielectric layer. The first dielectric sub-layer is rounded into a microlens. In this way, the microlens can be fabricated in a chip fabrication plant, without needing to deliver an associated chip to a dedicated microlens fabrication plant, thereby improving production efficiency and shortening the manufacturing cycle. The microlens can be fabricated in the optical device using a semiconductor process and thereby exhibits increased density and uniformity, resulting in higher optical efficiency.

### BRIEF DESCRIPTION OF THE DRAWINGS

FIGS. 1 to 3 are schematic cross-sectional views of structures resulting from steps in a process to fabricate an optical device, according to a first embodiment of the present invention.

FIGS. 4 to 9 are schematic partial cross-sectional views of structures resulting from steps in a process to form a microlens, according to the first embodiment of the present invention.

FIGS. 10 to 12 are schematic cross-sectional views of structures resulting from steps in a process to fabricate an optical device, according to a second embodiment of the present invention.

FIGS. 13 to 16 are schematic partial cross-sectional views of structures resulting from steps in a process to form a microlens, according to the second embodiment of the present invention.

FIGS. 17 to 20 are schematic cross-sectional views of structures resulting from steps in a process to fabricate an optical device, according to a third embodiment of the present invention.

### LIST OF REFERENCE NUMERALS

10 optical device; 100 substrate structure; 101 logic wafer; 102 pixel wafer; 103 rewiring layer; 110 base dielectric layer; 120 first dielectric layer; 121 opening; 122 first dielectric sub-layer; 123 second dielectric sub-layer; 120A edge surface portion; 120B edge surface portion; 130 first basic-pattern mask layer; 131 patterned mask layer; 132 narrow-width patterned mask layer; 140 microlens; R1 radius of curvature;

20 optical device; 200 substrate structure; 201 logic wafer; 202 pixel wafer; 203 rewiring layer; 210 base dielectric layer; 220 first dielectric layer; 221 opening; 222 first dielectric sub-layer; 223 second dielectric sub-layer; 230 second dielectric layer; 231 patterned mask layer; 231A edge portion; 231B central portion; 240 second basic-pattern mask layer; 250 microlens; R2 radius of curvature;

30 optical device; 300 substrate structure; 301 logic wafer; 302 pixel wafer; 303 rewiring layer; 310 base dielectric layer; 320 first dielectric layer; 321 opening; 322 first dielectric sub-layer; 3220 sub-sub-layer; 330 third basic-pattern mask layer; 340 third dielectric layer; 350 microlens; R3 radius of curvature.

Note that, in the embodiments illustrated below, the same reference numerals are sometimes used to indicate identical or functionally identical elements throughout different drawings, with any repeated description thereof being omitted. In some instances, like reference numerals and letters refer to like items. Therefore, once an item is defined in one figure, it would be unnecessary to further discuss it in any figure that follows.

### DETAILED DESCRIPTION

Optical devices and methods of fabricating the same provided in particular embodiments of the present invention will be described in detail below with reference to the accompanying drawings. From the following description, advantages and features of the present invention will be more apparent. Note that the figure is provided in a very simplified form not necessarily drawn to exact scale for the only purpose of helping to explain the disclosed embodiments in a more convenient and clearer way.

The terminology used herein is for the purpose of describing particular embodiments only and is not intended to be limiting of the invention. Unless defined otherwise herein, all technical and scientific terms used herein have the same meaning as commonly understood by one of ordinary skill in the art to which the invention belongs. As used herein and in the appended claims, the terms “first,” “second,” and the like do not denote any order, quantity, or importance, but rather are used to distinguish one element from another. Likewise, the terms “a” and “an” do not denote a limitation of quantity, but rather denote the presence of at least one of the referenced items. The terms “plurality” or “several” means two or more than two. Unless defined otherwise herein, the terms “upper”, “upper layer”, “lower”, “lower layer” and/or the like are merely for ease of description, and should not be construed as being limited to a particular position, or to a particular spatial orientation. The use of “including”, “comprising” or the like herein is meant to encompass the elements or items listed thereafter and equivalents thereof but do not preclude the presence of other elements or items. The terms “connected”, “coupled” or the like are not restricted to physical or mechanical connections or couplings, and can include electrical connections or couplings, whether direct or indirect. As used herein and in the appended claims, the singular forms “a”, “an”, and the” are intended to include the plural forms as well, unless the context clearly indicates otherwise. It will be also understood that, as used herein, the term “and/or” includes any and all combinations of one or more of the associated listed items.

### Example 1

Reference is made to FIGS. 1 to 3, which show schematic cross-sectional views of structures resulting from steps in a process to fabricate an optical device, according to a first embodiment of the present invention. As shown in FIG. 1, a substrate structure 100 is provided, which includes a first wafer 101, a second wafer 102 bonded to the first wafer 101, and a rewiring layer 103 on the second wafer 102. The first wafer 101 is for example a logic wafer, and the second wafer 102 is for example a pixel wafer. In other embodiments of the present application, the substrate structure 100 may be of a different structure. For example, the substrate structure 100 may include a single wafer structure defining logic, pixel and other areas. Alternatively, the substrate structure 100 may include a single chip, or a stack of chips. Still alternatively, the substrate structure 100 may include a wafer and a chip bonded to the wafer. Materials from which the substrate structure 100 can be fabricated may include semiconductor materials and non-semiconductor materials such as, for example, glass, ceramics, etc.

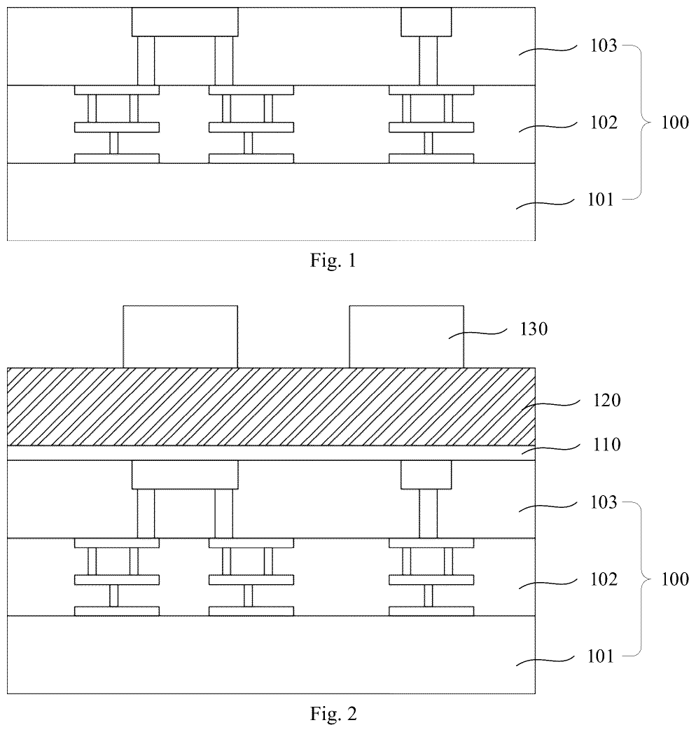

As shown in FIG. 2, in the present embodiment, a base dielectric layer 110 on the substrate structure 100 and a first dielectric layer 120 on the base dielectric layer 110 are then formed. The base dielectric layer 110 may serve as an etch stop layer and to provide protection to the substrate structure 100. In other embodiments of the present application, the first dielectric layer 120 may also be directly formed on the substrate structure 100. The base dielectric layer 110 and/or the first dielectric layer 120 may be formed of organic or inorganic material(s). In this embodiment, the base dielectric layer 110 is silicon nitride and serves mainly as an etch stop layer. The first dielectric layer 120 is silicon oxide, from which, a microlens is to be formed. The base dielectric layer 110 has a thickness of, for example, 500-2000 Å, and the first dielectric layer 120 has a thickness of, for example, 500-10000 Å. The materials and thicknesses of the base dielectric layer 110 and the first dielectric layer 120 are not limited to those described above, and any other suitable material or thickness known in the art is possible.

With continued reference to FIG. 2, in the present embodiment, a first mask layer (not shown) is formed on the first dielectric layer 120 and patterned into a first basic-pattern mask layer 130. The first mask layer may be formed of any material well known in the art. For example, it may be a hard mask layer, photoresist or the like. In the present embodiment, the first mask layer may be a photoresist layer, and the first basic-pattern mask layer 130 may, for example, include a plurality of photoresist mesas arranged into an array, from which an array of microlenses is to be formed. The first basic-pattern mask layer 130 may have a thickness of, for example, 500-20000 Å. However, the thickness of the first basic-pattern mask layer 130 is not limited to being in the aforementioned range.

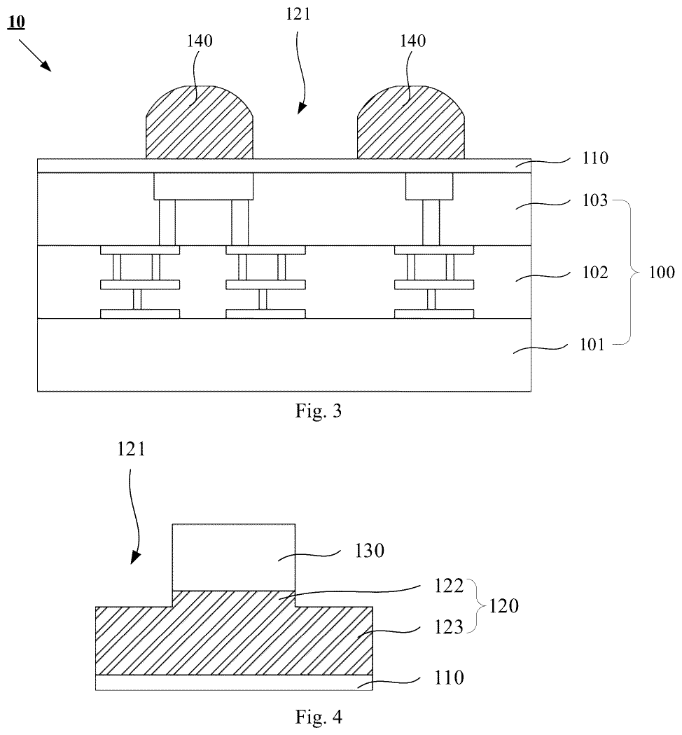

As shown in FIG. 3, in the present embodiment, with the first basic-pattern mask layer 130 serving as a mask, a patterning process is then carried out to remove portions of the first dielectric layer 120, forming openings 121 in the first dielectric layer 120. The openings 121 define at least one first dielectric sub-layer 122 in the first dielectric layer 120. The first dielectric sub-layer 122 is rounded, forming a microlens 140.

In particular, reference is now made to FIGS. 4 to 9, which show schematic partial cross-sectional views of structures resulting from steps in a process to form a microlens according to the first embodiment of the present invention. For the sake of clarity, FIGS. 4 to 9 only show portions of the base dielectric layer 110 and portions of the first dielectric layer 120.

As shown in FIG. 4, with the first basic-pattern mask layer 130 serving as a mask, an etching process is performed on the first dielectric layer 120 to locally reduce its thickness, for example, by 1/20-⅓. This thinning process may be controlled by selecting an appropriate etchant and appropriately configuring its duration. As a result, the openings 121 are formed in the first dielectric layer 120, which define a plurality of first dielectric sub-layers 122 therein (only one of them is shown in FIGS. 4 to 9, as an example). In the present embodiment, they also define second dielectric sub-layer(s) 123 below the first dielectric sub-layers 122. Cross-sections of the first dielectric sub-layers 122 taken parallel to a surface of the substrate structure have a width that is less than, equal to or greater than a width of cross-section(s) of the second dielectric sub-layer(s) 123 taken parallel to the surface of the substrate structure. The first dielectric sub-layers 122 and the second dielectric sub-layer(s) 123 may define steps therebetween.

With combined reference to FIGS. 2, 3 and 4, one or multiple second dielectric sub-layers 123 may be defined. In particular, the openings 121 may include a plurality of first sub-openings (not shown) extending a first direction and a plurality of second sub-openings (not shown) in a second direction. The first sub-openings intersect and communicate with the second sub-openings in a plane parallel to the substrate structure 100. Both the first and second directions are parallel to the surface of the substrate structure 100 and cross each other at angles. Preferably, the first and second directions are both parallel to the surface of the substrate structure and cross at right angles. Thus, the openings 121 may define a plurality of first dielectric sub-layers 122. The openings 121 extend through the first dielectric layer 120, or not, thereby further defining one or more second dielectric sub-layers 123.

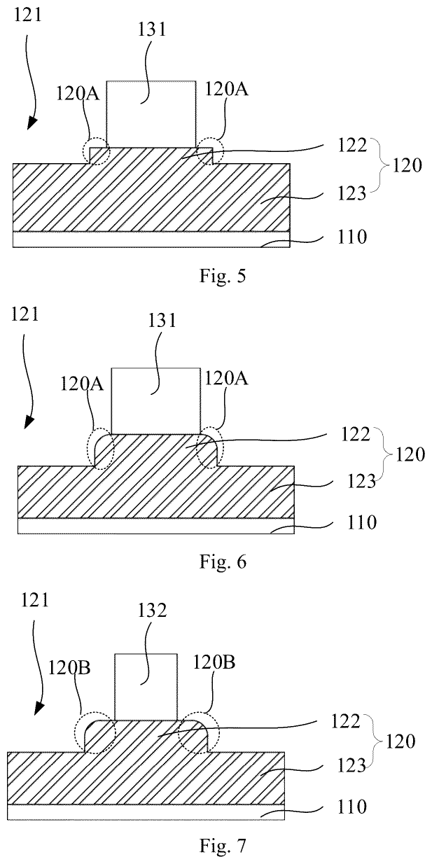

As shown in FIG. 5, the first basic-pattern mask layer 130 is then partially removed with its width narrowed, thereby forming a patterned mask layer 131 on the first dielectric sub-layers 122. As a result of the partial removal, the patterned mask layer 131 shrinks widthwise, and its thickness can also be reduced simultaneously, compared to the first basic-pattern mask layer 130. As a result of the widthwise shrinkage, edge surface portions 120A of the first dielectric sub-layers 122 are exposed from the patterned mask layer 131.

Next, as shown in FIG. 6, with the patterned mask layer 131 serving as a mask, top corners of the first dielectric sub-layers 122 are filleted. Specifically, the exposed edge surface portions of the first dielectric sub-layers 122 are etched to round the first dielectric sub-layers 122.

With continued reference to FIG. 6, in the present embodiment, at the same time as the first dielectric sub-layers 122 are rounded, the second dielectric sub-layers 123 are patterned. With combined reference to FIGS. 5 and 6, specifically, the first dielectric sub-layers 122 are rounded and the second dielectric sub-layers 123 are patterned and thinned within a single etching process. Patterning the second dielectric sub-layers 123 at the same time as the first dielectric sub-layers 122 are rounded can modify a thickness of the resulting microlenses.

Subsequently, as shown in FIG. 7, the patterned mask layer 131 is partially removed with its width narrowed, forming a narrow-width patterned mask layer 132. As a result of the partial removal, the narrow-width patterned mask layer 132 shrinks widthwise compared to the patterned mask layer 131, which has shrunken widthwise compared to the first basic-pattern mask layer 130. Moreover, as a result of the partial removal, the narrow-width patterned mask layer 132 is thinned compared to the patterned mask layer 131, which has been thinned compared to the first basic-pattern mask layer 130. Thus, edge surface portions 120B of the first dielectric sub-layers 122 are exposed from the narrow-width patterned mask layer 132. That is, the first dielectric layer 120 is more exposed.

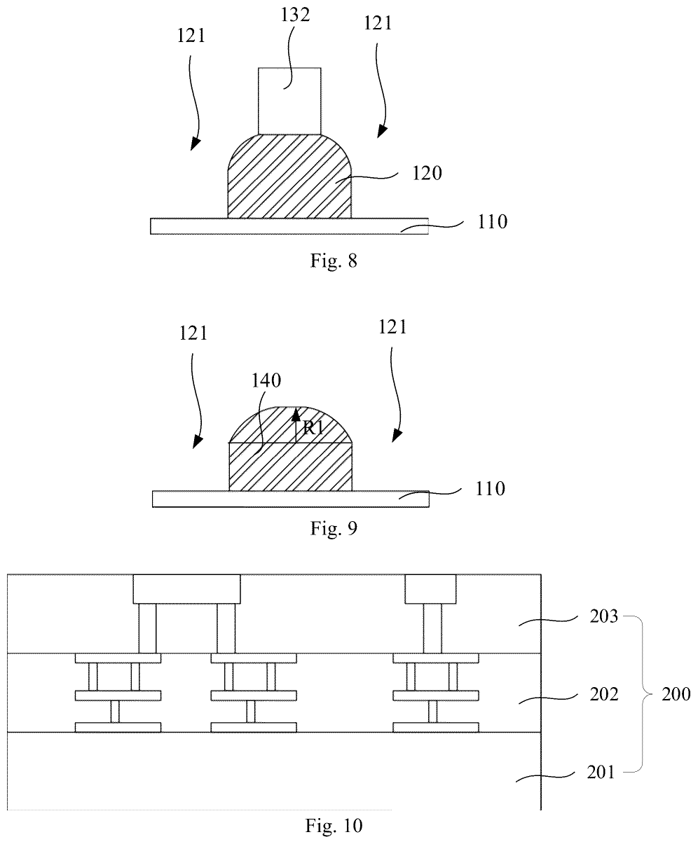

As shown in FIG. 8, with the narrow-width patterned mask layer 132 serving as a mask, the exposed edge surface portions 120B of the first dielectric sub-layers 122 are then etched. In the present embodiment, the remaining second dielectric sub-layers 123 may be simultaneously patterned and/or rounded using an etching process, which stops at a surface of the base dielectric layer 110, thereby forming the microlens 140. In other embodiments of the present application, the etching process may stop within the second dielectric sub-layers 123 and be followed by repeating the following steps once or more times: partially removing the narrow-width patterned mask layer 132 with its width narrowed to expose edge surface portions of the first dielectric sub-layers 122; and with a patterned mask layer resulting from the partial removal serving as a mask, etching both the exposed edge surface portions of the first dielectric sub-layers 122 and the second dielectric sub-layers 123. The last etching process stops at the surface of the base dielectric layer 110, resulting in the formation of the microlenses 140. Through performing multiple etching processes on the first dielectric layer 120, the morphology of the resulting microlenses 140, such as a radius of curvature R1 thereof, can be modified to improve its quality and reliability. In the present embodiment, the radius of curvature R1 of the microlenses 140 lies between 500 Å and 10000 Å. In other embodiments, the radius of curvature R1 of the microlenses 140 may be less than 500 Å, or greater than 10000 Å.

In the present embodiment, as shown in FIG. 9, the narrow-width patterned mask layer 132 is then stripped away, exposing the microlens 140. For example, the narrow-width patterned mask layer 132 may be removed by ashing or the like.

With continued reference to FIG. 3, an optical device 10 is thus obtained, which includes the substrate structure 100 and the microlenses 140 above the substrate structure 100. The microlenses 140 are formed by patterning and rounding the first dielectric layer 120 on the substrate structure 100. In the present embodiment, the optical device 10 further includes the base dielectric layer 110 on the substrate structure 100, and the microlenses 140 reside on the base dielectric layer 110.

In the optical device and method of this embodiment, the first dielectric layer 120 is formed on the substrate structure 100 and then patterned and partially removed, forming openings 121 therein, which define at least one first dielectric sub-layer 122 in the first dielectric layer 120. The first dielectric sub-layer 122 is rounded into a microlens 140. In this way, the microlens 140 can be fabricated in a chip fabrication plant, without needing to deliver an associated chip to a dedicated microlens fabrication plant, thereby improving production efficiency and shortening the manufacturing cycle. The microlens 140 can be fabricated in the optical device 10 using a semiconductor process and thus exhibits increased density and uniformity, resulting in higher optical efficiency.

### Example 2

Reference is made to FIGS. 10 to 12, which show schematic cross-sectional views of structures resulting from steps in a process to fabricate an optical device, according to a second embodiment of the present invention. As shown in FIG. 10, a substrate structure 200 is provided. In this embodiment, the substrate structure 200 includes a first wafer 201, a second wafer 202 bonded to the first wafer 201, and a rewiring layer 203 on the second wafer 202. The first wafer 201 is for example a logic wafer, and the second wafer 202 is for example a pixel wafer. In other embodiments of the present application, the substrate structure 200 may be of a different structure. For example, the substrate structure 200 may include a single wafer structure defining logic, pixel and other areas. Alternatively, the substrate structure 200 may include a single chip, or a stack of chips. Still alternatively, the substrate structure 200 may include a wafer and a chip bonded to the wafer. Materials from which the substrate structure 200 can be fabricated may include semiconductor materials and non-semiconductor materials such as, for example, glass, ceramics, etc.

As shown in FIG. 11, in the present embodiment, a base dielectric layer 210 on the substrate structure 200 and a first dielectric layer 220 on the base dielectric layer 210 are then formed. The base dielectric layer 210 and/or the first dielectric layer 220 may be formed of organic or inorganic material(s). In this embodiment, the base dielectric layer 210 is silicon nitride and serves mainly as an etch stop layer. The first dielectric layer 220 is silicon oxide, from which, a microlens is to be formed. The base dielectric layer 210 has a thickness of, for example, 500-2000 Å, and the first dielectric layer 220 has a thickness of, for example, 500-10000 Å. The materials and thicknesses of the base dielectric layer 210 and the first dielectric layer 220 are not limited to those described above, and any other suitable material or thickness known in the art is possible.

Additionally, a second dielectric layer 230 is formed on the first dielectric layer 220, and a second mask layer (not shown) on the second dielectric layer 230. The second mask layer may be formed of any material well known in the art. For example, it may be a hard mask layer, photoresist or the like. In the present embodiment, the second mask layer is a photoresist layer. Preferably, the second dielectric layer 230 has a thickness of 500-2000 Å. The second mask layer may have a thickness of, for example, 500-20000 Å. The second mask layer is then patterned into a second basic-pattern mask layer 240, which may include a plurality of photoresist mesas arranged into an array, for example. The thicknesses of the second mask layer and the second dielectric layer 230 are not limited to being in the aforementioned ranges.

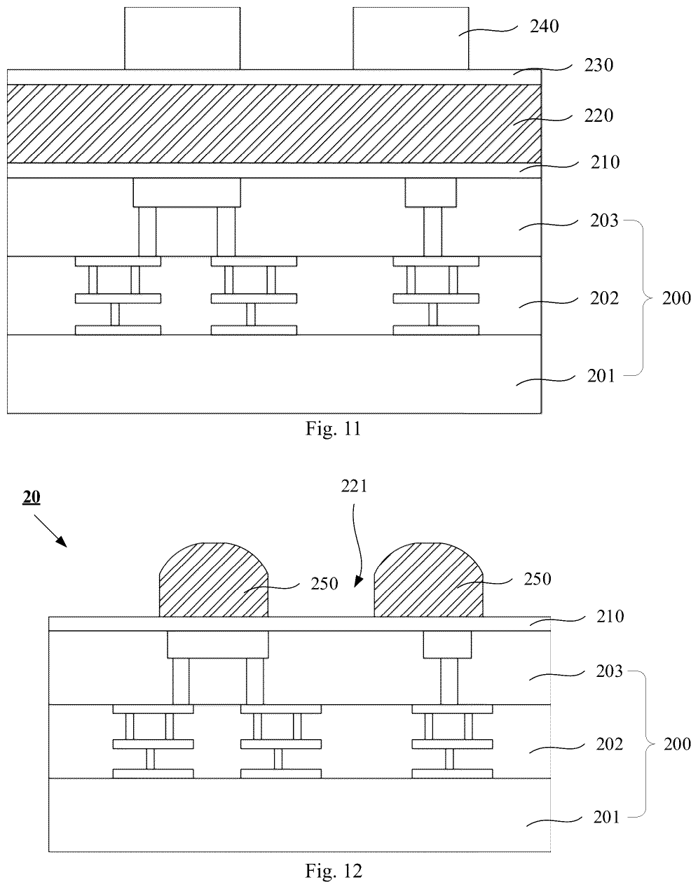

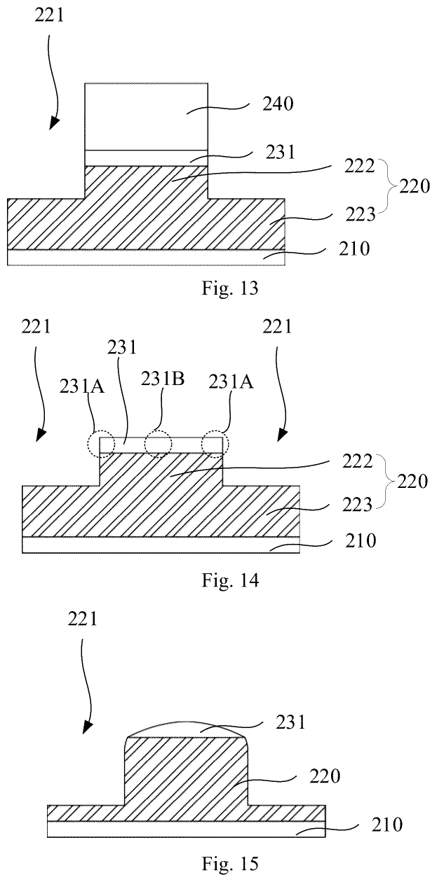

As shown in FIG. 12, in conjunction with FIG. 13, with the second basic-pattern mask layer 240 serving as a mask, the second dielectric layer 230 is etched into a patterned mask layer 231. In the present embodiment, the patterned mask layer 231 is a dielectric material. That is, the patterned mask layer 231 is a second patterned dielectric layer. In the etching process, the first dielectric layer 220 is locally thinned, forming openings 221 therein, which define at least one first dielectric sub-layer 222 in the first dielectric layer 220. In the present embodiment, the openings 221 also define a second dielectric sub-layer 223 in the first dielectric layer 220 below the first dielectric sub-layer 222. A cross-section of the first dielectric sub-layer 222 taken parallel to a surface of the substrate structure may have a width that is less than, equal to or greater than a width of a cross-section of the second dielectric sub-layer 223 taken parallel to the surface of the substrate structure. The first dielectric sub-layer 222 and the second dielectric sub-layer 223 may define a step therebetween. For example, the first dielectric layer 220 may be etched so that its thickness is locally reduced by 1/10-⅔, thereby forming the openings 221, which define the first dielectric sub-layer 222 and the second dielectric sub-layer 223. The thinning process may be controlled by selecting an appropriate etchant and appropriately configuring its duration.

As shown in FIG. 14, in the present embodiment, the second basic-pattern mask layer 240 is removed, exposing the patterned mask layer 231. In particular, the second basic-pattern mask layer 240 may be removed by ashing or the like.

With continued reference to FIG. 14, this embodiment differs from the first embodiment in that the patterned mask layer 231 covers edge surface portions of the first dielectric sub-layer 222. That is, the patterned mask layer 231 covers the entire surface of the first dielectric sub-layer 222. As used herein, the term “surface” particularly refers to a top surface, and “side surface” refers to a side face. At edge portions 231A of the patterned mask layer 231, an etch selectivity ratio of the first dielectric sub-layer 222 to the patterned mask layer 231 is less than X:1. At a central portion 231B of the patterned mask layer 231, an etch selectivity ratio of the first dielectric sub-layer 222 to the patterned mask layer 231 is greater than X:1. That is, an etch selectivity ratio of the first dielectric layer 220 to the edge portions 231A of the patterned mask layer 231 is less than X:1, while an etch selectivity ratio of the first dielectric layer 220 to the central portion 231B of the patterned mask layer 231 is greater than X:1. In this way, when etched subsequently, the first dielectric sub-layer 222 is more removed at the edge portions 231A than at the central portion 231B, forming a microlens with a curved surface.

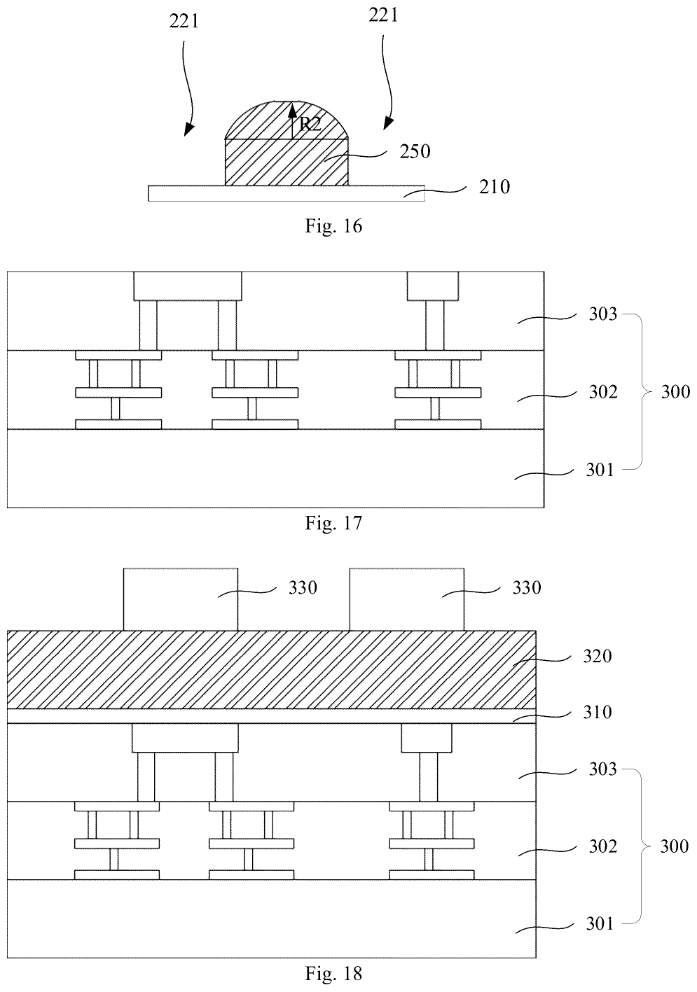

Next, as shown in FIGS. 15 and 16, with the patterned mask layer 231 as a mask, the first dielectric sub-layer 222 is etched into a microlens 250. In the present embodiment, the second dielectric sub-layer 223 is simultaneously patterned and/or rounded. As shown in FIG. 15, during the etching of the first dielectric layer 220, the patterned mask layer 231 is also consumed gradually. Specifically, the edge portions 231A of the patterned mask layer 231 are consumed faster than the central portion 231B of the patterned mask layer 231. Accordingly, portions of the first dielectric sub-layer 222 or the first dielectric layer 220 corresponding to the edge portions 231A are more etched away than a portion thereof corresponding to the central portion 231B. As such, as shown in FIG. 16, a microlens 250 with a curved surface is obtained.

Preferably, X lies between 5 and 20. That is, X is greater than or equal to 5 and less than or equal to 20. In the present embodiment, X may be configured at an appropriate value, which allows the microlens 250 to have a desired radius of curvature R2. A greater value of X may lead to a greater radius of curvature R2 of the microlens 250.

With continued reference to FIGS. 12 and 16, an optical device 20 is thus obtained, the optical device 20 includes the substrate structure 200 and the microlens 250 above the substrate structure 200. The microlens 250 is formed by patterning and rounding the first dielectric layer 220 on the substrate structure 200. In the present embodiment, the optical device 20 further includes the base dielectric layer 210 on the substrate structure 200, and the microlens 250 resides on the base dielectric layer 210.

### Example 3

Reference is made to FIGS. 17 to 20, which show schematic cross-sectional views of structures resulting from steps in a process to fabricate an optical device, according to a third embodiment of the present invention. As shown in FIG. 17, a substrate structure 300 is provided. In this embodiment, the substrate structure 300 includes a first wafer 301, a second wafer 302 bonded to the first wafer 301, and a rewiring layer 303 on the second wafer 302. The first wafer 301 is for example a logic wafer, and the second wafer 302 is for example a pixel wafer. In other embodiments of the present application, the substrate structure 300 may be of a different structure. For example, the substrate structure 300 may include a single wafer structure defining logic, pixel and other areas. Alternatively, the substrate structure 300 may include a single chip, or a stack of chips. Still alternatively, the substrate structure 300 may include a wafer and a chip bonded to the wafer. Materials from which the substrate structure 300 can be fabricated may include semiconductor materials and non-semiconductor materials such as, for example, glass, ceramics, etc.

As shown in FIG. 18, in the present embodiment, a base dielectric layer 310 on the substrate structure 300 and a first dielectric layer 320 on the base dielectric layer 310 are then formed. The base dielectric layer 310 and/or the first dielectric layer 320 may be formed of organic or inorganic material(s). In this embodiment, the base dielectric layer 310 is silicon nitride and serves mainly as an etch stop layer. The first dielectric layer 320 is silicon oxide, from which, a microlens is to be formed. The base dielectric layer 310 has a thickness of, for example, 500-2000 Å, and the first dielectric layer 320 has a thickness of, for example, 500-10000 Å. The materials and thicknesses of the base dielectric layer 310 and the first dielectric layer 320 are not limited to those described above, and any other suitable material or thickness known in the art is possible.

With continued reference to FIG. 18, in the present embodiment, a third mask layer (not shown; the first, second and third first mask layers in the first, second and third embodiments may be each called the mask layer) is formed on the first dielectric layer 320. In the present embodiment, the third mask layer may be the same as the first mask layer in the first embodiment, or as the second mask layer in the second embodiment. The third mask layer is patterned into a third basic-pattern mask layer 330. The third mask layer may be formed of any material well known in the art. For example, it may be a hard mask layer, photoresist or the like. In the present embodiment, the third mask layer is a photoresist layer, and the third basic-pattern mask layer 330 may, for example, include a plurality of photoresist mesas arranged into an array, from which an array of microlenses is to be formed. The third basic-pattern mask layer 330 may have a thickness of, for example, 500-20000 Å. However, the thickness of the third basic-pattern mask layer 330 is not limited to being in the aforementioned range.

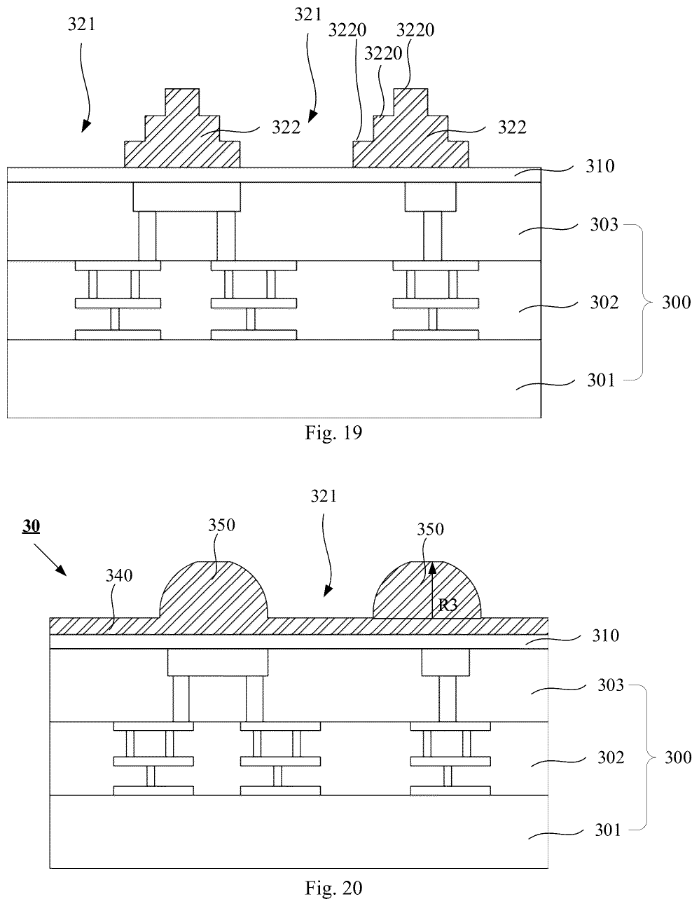

As shown in FIG. 19, with the third basic-pattern mask layer 330 serving as a mask, the first dielectric layer 320 is patterned and partially removed, forming openings 321 therein, which define at least one first dielectric sub-layer 322 in the first dielectric layer 320. The base dielectric layer 310 is partially exposed in the openings 321. That is, openings 321 extend through the first dielectric layer 320 and define the at least one first dielectric sub-layer 322 in the first dielectric layer 320. In another embodiment, the base dielectric layer 310 may not be exposed in the openings 321. That is, the openings 321 do not extend through the first dielectric layer 320. In this case, they also define a second dielectric sub-layers (not shown) in the first dielectric layer 320. The first dielectric sub-layer 322 resides above the second dielectric sub-layer. A cross-section of the first dielectric sub-layer 322 taken parallel to a surface of the substrate structure may have a width that is less than, equal to or greater than a width of a cross-section of the second dielectric sub-layer taken parallel to the surface of the substrate structure. The first dielectric sub-layer 322 and the second dielectric sub-layer may define a step therebetween.

With continued reference to FIG. 19, in the present embodiment, the first dielectric sub-layer 322 includes at least two sub-sub-layers 3220 having cross-sectional widths measured parallel to the surface of the substrate structure 300, which progressively increase from the side away from the substrate structure 300 to the side proximal to the substrate structure 300. A step may be defined between each pair of adjacent sub-sub-layers 3220. The at least two sub-sub-layers 3220 may be formed using any approach well known in the art. In the figures, three sub-sub-layers 3220 are illustrated, as an example, and their cross-sectional widths increase layer by layer from the top downwards. The topmost sub-sub-layer 3220 is exposed on the middle sub-sub-layer 3220, which is in turn exposed on the bottommost sub-sub-layer 3220. Thus, three steps are defined in this structure.

Next, as shown in FIG. 20, a third dielectric layer 340 is formed, which covers at least side surfaces of the first dielectric sub-layer 322, thereby forming curved surfaces that connect a surface of the first dielectric sub-layer 322 to the side surfaces thereof. Thus, a microlens 350 is obtained. It is to be noted that, prior to the formation of the third dielectric layer 340, the at least two sub-sub-layers 3220 may be formed so that a surface of each sub-sub-layer 3220 is connected to side surfaces thereof by curved surfaces, due to limitations of the process used. In the present embodiment, the third dielectric layer 340 further covers the surface of the first dielectric sub-layer 322. That is, the third dielectric layer 340 covers the top and side surfaces of each sub-sub-layer 3220. In particular, the third dielectric layer 340 may be formed using a deposition process. The third dielectric layer 340 rounds the first dielectric sub-layer 322, and the resulting microlens 350 therefore has a curved surface, which allows the microlens 350 to have improved quality and reliability. In the present embodiment, the third dielectric layer 340 also covers the exposed base dielectric layer 310, allowing the microlens 350 to be formed using a simpler process. In the present embodiment, the microlens 350 has a radius of curvature R3 lying between 500 Å and 10000 Å. In other embodiments, the radius of curvature R3 of the microlens 350 may be less than 500 Å, or greater than 10000 Å.

A corresponding optical device is also provided in this present embodiment. With continued reference to FIG. 20, the optical device 30 includes the substrate structure 300 and the microlens 350 on the substrate structure 300. The microlens 350 is formed by patterning and rounding the first dielectric layer 320 on the substrate structure 300 and then forming the third dielectric layer 340 over it. In the present embodiment, the optical device 30 further includes the base dielectric layer 310 on the substrate structure 300, and the microlens 350 resides on the base dielectric layer 310.

As used herein, any reference to “one embodiment” or “some embodiments” means that a particular feature, structure, or characteristic described in connection with the embodiment is included in at least one embodiment or at least some embodiments disclosed herein. Therefore, the appearances of the phrase “in one embodiment” or “in some embodiments” in various places in the specification are not necessarily all referring to the same one or some embodiments. Further, in one or more embodiments, features, structures or characteristics may be combined in any suitable combination and/or sub-combination.

While a few particular embodiments of the present application have been described in detail by way of examples, those skilled in the art will understand that the foregoing examples are provided for illustration only rather than any limitation on the scope of the application. The various embodiments disclosed herein can be combined in any combination, without departing from the spirit and scope of the application. Those skilled in the art will also understand that various modifications can be made to the embodiments, without departing from the scope and spirit of the application. The scope of the application is defined by the appended claims.

1. A method of fabricating an optical device, comprising:
providing a substrate structure;
forming a first dielectric layer on the substrate structure; and
patterning and thereby partially removing the first dielectric layer to form openings therein, the openings defining at least one first dielectric sub-layer in the first dielectric layer, and rounding the first dielectric sub-layer into a microlens.

2. The method of claim 1, wherein rounding the first dielectric sub-layer comprises: forming a patterned mask layer on the first dielectric sub-layer and etching portions of the first dielectric sub-layer connecting a surface and side surfaces thereof, with the patterned mask layer serving as a mask, thereby forming curved surfaces.

3. The method of claim 2, wherein edge surface portions of the first dielectric sub-layer are exposed from the patterned mask layer, wherein etching the portions of the first dielectric sub-layer connecting the surface and the side surfaces thereof comprises: etching the edge surface portions of the first dielectric sub-layer.

4. The method of claim 3, wherein forming the patterned mask layer comprises:
forming a first mask layer on the first dielectric layer;
patterning the first mask layer into a first basic-pattern mask layer and, with the first basic-pattern mask layer serving as a mask, etching and thinning the first dielectric layer to form the openings; and
partially removing the first basic-pattern mask layer with its width narrowed to form the patterned mask layer.

5. The method of claim 4, wherein after etching the portions of the first dielectric sub-layer connecting the surface and the side surfaces thereof, rounding the first dielectric sub-layer further comprises:
repeating, once or multiple times, a process consisting of: partially removing the patterned mask layer with its width narrowed to expose edge surface portions of the first dielectric sub-layer; and
with a patterned mask layer resulting from the partial removal serving as a mask, etching the exposed edge surface portions of the first dielectric sub-layer.

6. The method of claim 2, wherein the patterned mask layer covers edge surface portions of the first dielectric sub-layer, wherein etching the portions of the first dielectric sub-layer connecting the surface and the side surfaces thereof comprises: etching the first dielectric sub-layer at an etch selectivity ratio less than X:1 of the first dielectric sub-layer to edge portions of the patterned mask layer and at an etch selectivity ratio greater than X:1 of the first dielectric sub-layer to a central portion of the patterned mask layer.

7. The method of claim 6, wherein forming the patterned mask layer comprises:
successively forming a second dielectric layer and a second mask layer above the first dielectric layer; and
patterning the second mask layer into a second basic-pattern mask layer, etching the second dielectric layer to form the patterned mask layer, with the second basic-pattern mask layer serving as a mask, and thinning the first dielectric layer to form the opening.

8. The method of claim 6, wherein X is between 5 and 20.

9. The method of claim 1, wherein rounding the first dielectric sub-layer comprises: forming a third dielectric layer, which covers at least side surfaces of the first dielectric sub-layer, thereby forming curved surfaces connecting a surface of the first dielectric sub-layer to the side surfaces thereof.

10. The method of claim 9, wherein the first dielectric sub-layer comprises at least two sub-sub-layers having cross-sectional widths measured parallel to a surface of the substrate structure, which progressively increase from the side away from the substrate structure to the side proximal to the substrate structure,
wherein the third dielectric layer covers side surfaces of each sub-sub-layer.

11. The method of claim 10, wherein three sub-sub-layers are formed, a topmost one of the sub-sub-layers is exposed on a middle one of the sub-sub-layers, the middle one of the sub-sub-layers is exposed on a bottommost one of the sub-sub-layers, thus, three steps are defined.

12. The method of claim 1, wherein the openings further define a second dielectric sub-layer in the first dielectric layer, wherein the first dielectric layer is formed on the second dielectric sub-layer.

13. The method of claim 12, wherein at the same time as the first dielectric sub-layer is rounded, the second dielectric sub-layer is patterned and/or rounded.

14. The method of claim 12, wherein a cross-sectional width of the first dielectric sub-layer measured parallel to a surface of the substrate structure is less than or equal to a cross-sectional width of the second dielectric sub-layer measured parallel to the surface of the substrate structure.

15. The method of claim 12, wherein a cross-sectional width of the first dielectric sub-layer measured parallel to a surface of the substrate structure is greater than a cross-sectional width of the second dielectric sub-layer measured parallel to the surface of the substrate structure.

16. The method of claim 12, wherein the first dielectric sub-layer and the second dielectric sub-layer define steps therebetween.

17. An optical device comprising a substrate structure and a microlens on the substrate structure, wherein the microlens is formed by patterning and rounding a first dielectric layer on the substrate structure.

18. The optical device of claim 17, wherein the microlens is made of silicon oxide.

19. The optical device of claim 17, wherein the microlens is obtained according to a method, comprising;
providing the substrate structure;
forming the first dielectric layer on the substrate structure; and
patterning and thereby partially removing the first dielectric layer to form openings therein, the openings defining at least one first dielectric sub-layer in the first dielectric layer, and rounding the first dielectric sub-layer into the microlens.
